(19) United States
(12) Patent Application Publication
(10) Pub. No.: US 2017/0142454 A1
(43) Pub. Date: May 18, 2017

(54) THIRD-PARTY VIDEO PUSHING METHOD AND SYSTEM

(71) Applicants: LE HOLDINGS (BEIJING) CO., LTD., Beijing (CN); LECLOUD COMPUTING CO., LTD., Beijing (CN)

(72) Inventor: Yuhan JIANG, Beijing (CN)

(73) Assignees: LE HOLDINGS (BEIJING) CO., LTD., Beijing (CN); LECLOUD COMPUTING CO., LTD., Beijing (CN)

(21) Appl. No.: 15/252,252

(22) Filed: Aug. 31, 2016

Related U.S. Application Data
(63) Continuation of application No. PCT/CN2016/083022, filed on May 23, 2016.

(30) Foreign Application Priority Data
Nov. 13, 2015 (CN) 201510779722.6

(51) Int. Cl. H04N 21/237; H04N 21/231; H04N 21/258

(52) U.S. Cl. CPC H04N 21/237; H04N 21/25816; H04N 21/23109

(57) ABSTRACT

Disclosed are a method and system for pushing video to a third party, the method including: receiving a video request instruction from a third party, the video request instruction including third-party identification authentication information and third-party video stream identification information; retrieving a prestored list of local video streams corresponding to a third party ID according to the third-party identification ID authentication information; determining a video stream to be pushed by comparing the third-party video stream identification information with local video stream configuration information in the list of local video streams; pushing the video stream to be pushed to the third party. Sharing of different video streams between different video platforms is implemented by presetting a video stream matching list in a server, and a response to a video request between different websites is implemented.

### CROSS REFERENCE TO RELATED APPLICATIONS

This application is a continuation of International Application No. PCT/CN2016/083022, filed on 23 May 2016, which is based upon and claims priority to Chinese Patent Application No. 201510779722.6, filed on 13 Nov. 2015, the entire contents of which are incorporated herein by reference.

### TECHNICAL FIELD

The disclosure relates to the technical field of online videos, and more particularly to a method for pushing video to a third party and an electronic device.

### BACKGROUND

Each video website is aggressively expanding business with rapid development of Internet technologies. In order to attract more users, each video website, e.g., LETV, Youku, SOHU, iQIYI and the like, is doing their utmost to enrich the respective video content, and continually expanding contents of video libraries for their websites. Use of video pushing technologies in daily life has become popular. Amongst these, a server of the each video website can receive a video request instruction from an electronic terminal in which this video website client is installed, or receive a video request instruction directly transmitted from this video website, and acquire the corresponding video streams in a media resource library of this video website according to video stream identification information included in the video request instruction, and push the acquired video streams to the electronic terminal or video website per se which transmits the video request instruction, so as to implement pushing of video streams.

During a video stream pushing process in the prior art, pushing of a video “within” this video website is implemented. That is, the server of this video website can only receive the video request instruction from the electronic terminal in which this video website client is installed, or receive the video request instruction directly transmitted from this video website, and push out the video in the media resource library of this video website.

However, there exists a problem that there is no effective method for implementing a response to a video request between different websites. That is, some video website, e.g., LETV, cannot respond to a video request instruction of a third-party video website or terminal, e.g., Youku or an electronic terminal for which a Youku client is installed, and cannot access media resources in a media resource library of a third-party video website in addition to the present video website by a video website, resulting that sharing of resources between different video websites cannot be realized. As a result, user experience can be negatively affected.

### SUMMARY

The application provides a method for pushing video to a third party and an electronic device for solving a technical problem that each video operation platform cannot share each other's media resource library in the prior art.

According to an aspect of the disclosure, there is provided a method for pushing video to a third party, the method including:

receiving a video request instruction from a third party, the video request instruction including third-party identification authentication information and third-party video stream identification information;

retrieving a prestored list of local video streams corresponding to the third party ID according to the third-party ID authentication information;

determining a video stream to be pushed by comparing the third-party video stream identification information with local video stream configuration information in the list of local video streams; and

pushing the video stream to be pushed to the third party.

According to a further aspect of the disclosure, there is provided an electronic device including: at least one processor; and a memory communicably connected with the at least one processor for storing instructions executable by the at least one processor, wherein execution of the instructions by the at least one processor causes the at least one processor to execute the method for pushing video to a third party mentioned above.

According to yet another aspect of the disclosure, there is provided a non-transitory computer-readable storage medium storing executable instructions that, when executed by an electronic device, cause the electronic device to execute the method for pushing video to a third party mentioned above.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a flow chart of an embodiment of a method for pushing video to a third party of the disclosure;

FIG. 2 is a schematic view of the video classification information configuration of the disclosure;

FIG. 3 is a schematic view of an embodiment of a system for pushing video to a third party of the disclosure;

FIG. 4 shows an architecture diagram of an embodiment in which the method and system for pushing video to a third party of the disclosure are implemented; and

FIG. 5 is a schematic view of an electronic device or a server included in the system for pushing video to a third party according to an embodiment of the disclosure.

### DETAILED DESCRIPTION

In order to make the purpose, technical solutions, and advantages of the embodiments of the invention more clearly, technical solutions of the embodiments of the disclosure will be described clearly and completely in conjunction with the figures. Obviously, the described embodiments are merely part of the embodiments of the disclosure, but not all embodiments. Based on the embodiments of the disclosure, other embodiments obtained by the ordinary skill in the art without inventive efforts are within the scope of the disclosure.

It should be noted that embodiments and features of the embodiments in the present application can be combined with one another in case of no conflicts.

The disclosure is applicable to various general-purpose and specific-purpose computer system environments or configurations, such as a personal computer, a server computer, a handheld device or portable device, a tablet device, a multi-processor system, a microprocessor-based system, a set-top box, a programmable consumer electronic device, a network PC, a mini-computer, a mainframe computer, a distributed computing environment including any of the above-listed systems or devices.

The disclosure can be described in a general context where a computer executes computer-executable instructions, such as program modules. Typically, program modules include routines, programs, objects, components, data structures, etc. which perform certain tasks or implement certain abstract data types. The disclosure can also be implemented in a distributed computing environment, where tasks are performed by a remote processing device connected through a communication network. In a distributed computing environment, program modules may be stored in storage mediums including memory device of the local and remote computer.

In the disclosure, terms like “component”, “device”, and “system” etc. refer to relevant entity applied in a computer, such as hardware, a combination of hardware and software, software or software under execution. In particular, for example, a module may be, but not limited to a process executed in a processor, a processor, an object, an executable component, an execution thread, a program and/or a computer. Further, an application or script routine or a server may also constitute a component. One or more components can exist in an implemented process and/or thread, and the component can be localized in one computer and/or distributed in two or more computers, and can be stored in any computer readable medium. The component can also conduct communication through local and/or remote process according to signals including one or more data package, such as a signal coming from a data to be interacted with another component of a local system, and/or a signal of data to be interacted with other system through signal in the network of internet.

Finally, it should also be noted that, wordings like first and second are merely for separating one entity or operation from the other, but not intended to require or imply a relation or sequence among these entities or operations. Further, terms like “include”, “including”, and the like are to be construed as including not only the elements described, but also those elements not specifically described, or further including elements which are essential to such process, method, article or device. Unless the context clearly requires, throughout the description and the claims, elements defined by recitation with “including . . . ” should not be construed as exclusive from the process, method, article or device including said elements of other equivalent elements.

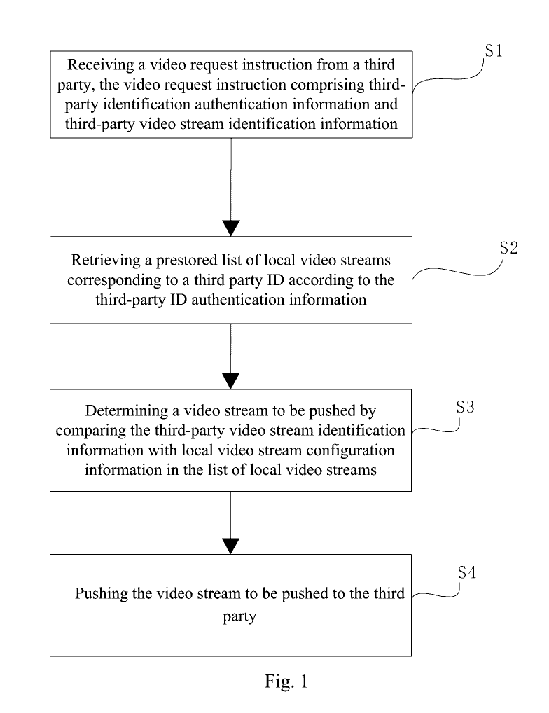

As shown in FIG. 1, the method for pushing video to a third party of an embodiment of the disclosure includes the following steps.

In S1, a server receives a video request instruction from a third party, the video request instruction including third-party identification authentication information and identification information on a third-party video stream.

In S2, the server retrieves a prestored list of video streams corresponding to a third party ID in a memory of the server according to the third-party ID authentication information in the video request instruction received from the third party.

In S3, the server determines a video stream to be pushed by comparing the identification information on the third-party video stream with local video stream configuration information in the retrieved list of video streams.

In S4, the server pushes the determined video stream to be pushed to the third party.

In some embodiments (taking LETV and Mango TV as examples), the media resource library employed by LETV is composed by itself, while mango TV employs a media resource library of SOBEY. Therefore, the architectures of two media resource libraries are completely different, and thus the video stream identification information with which the two media resource libraries manage respective video streams is also different. As a result, it is impossible for the two video platforms to directly access to each other's media resource library mutually. However, the above embodiment realizes access between LETV and mango TV by presetting a video stream matching list in a local server, i.e., the server of LETV, and performing the method as shown in FIG. 1 for the received third party's video request instruction.

The third party transmitting a video request instruction in embodiments of the disclosure may be a device providing to users voice and/or data connectivity, which may be a mobile terminal, such as a cell phone and a computer having a mobile terminal. For example, it may be a portable, pocket-sized, hand-held, computer's built-in or in-vehicle mobile device, may also be a PC (personal computer), and may also be a smart television capable of being connected to Internet.

In the embodiment described above, the video stream matching list stored in the server can be divided into two columns and at least one row. The first column stores local video stream configuration information on the video to be pushed in a local media resource library, and a second column stores the third-party video stream identification information on the video to be pushed in the third party media resource library. The third party video stream identification information and local video stream configuration information correspond to each other in each row.

Regarding configurations of the video stream matching list described above, in particular, videos that Mango TV intends to access but does not exist in the media resource library of Mango TV (i.e., the media resource library of SOBEY) need to be determined. The videos that Mango TV needs to access are selected from the media resource library of LETV. The video stream information on those videos is stored in the first column of the video stream matching list. Then, the video stream identification information on the videos that Mango TV needs to access is stored in the second column of the video stream matching list. For instance, the video stream identification information on a first video requested, as extracted from the media resource library of LETV is stored in a first row of the first column of the video stream matching list. The video stream identification information on the requested video which is acquired from the server of Mango TV is stored in a first row of the second column of the video stream matching list. Filling up of the video stream matching list is thus completed in such one-to-one correspondence.

Generation and configuration of the video stream matching list in the embodiment described above can be automatically completed by the server.

In the embodiment described above, the local video stream configuration information at least includes identification information and address information on the video stream to be pushed in a local media resource library, and further includes address information and video content information on the video stream to be pushed. The local server (the server of LETV) extracts a corresponding video from a media resource library according to the address information and video content information on the video stream to be pushed.

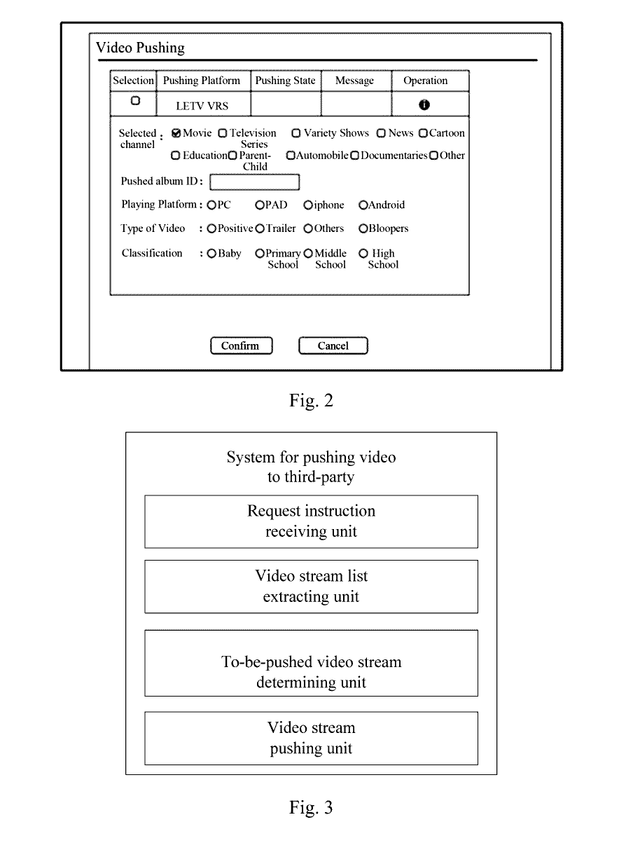

As shown in FIG. 2, the identification information on the requested video stream further includes classification information including a pushing platform, a selected channel, a pushed album, a playing platform, a type of a video, a video classification and the like. The classification information includes the above-mentioned categories but is not limited thereto, and can be properly increased or decreased according to particular requirements. The classification information indicates a classification management of the requested video within Mango TV. Depending upon the above-mentioned classification information, the local server (the server of LETV) can accurately conduct playing according to the classification of the pushed video within Mango TV.

More preferably, in the embodiment discussed above, the identification information on the video stream to be pushed further includes code rate information on the video stream to be pushed. For example, the video code rate can be the number of data bits transmitted in a time unit upon transmission of video data, typically in units of kbps, i.e., kilobits per second. The code rate can be understood as a sampling rate. The greater the sampling rate per unit of time is, the higher the precision is. As a result, the processed file gets closer to an original file. However, a file size is directly proportional to the sampling rate, and therefore almost all of encoding formats place a premium on how to achieve the least distortion with the lowest code rate. For example, as for an audio, the higher the code rate thereof, the smaller the compressed proportion, and the smaller the loss of audio quality, the closer it gets to an audio quality of an audio source.

As the same video in the media resource library of LETV tends to include a plurality of code rates, if the code rate of the video pushed to mango TV is unsuitable for playing on a platform of mango TV, it needs to make a request and push it once again. It even directly fails in pushing, and ultimately results in a failure in user's access to videos and creates negative user experience.

On the other hand, with the video stream identification information on the video to be pushed including code rate information, it is possible to directly push a code rate video suitable for playing by Mango TV to Mango TV, which ensures the stability and success rate of video pushing, and enhances user experience.

In any of the embodiments described above, the local media resource library serves at least one third-party platform. Accordingly, the local server (the server of LETV) includes a plurality of lists of local video streams. Each local video stream matching list corresponds to a third party media resource library, e.g., the media resource library of Mango TV, or the media resource library of Youku, or the media resource library of SOHU and the like, so as to implement a mutual direct access to media resources among plural platforms.

It should be noted that all the embodiments described above take videos as an example for illustration, and are not limited to videos but may also be any media resources such as audios, files, websites and the like. In the embodiment described above, sharing of different video streams between different video platforms is implemented by presetting the video stream matching list in the local server, and the response to the video request between different websites is implemented. That is, some video website, e.g., LETV, can respond to a video request instruction of a third-party video website or terminal, e.g., Youku or an electronic terminal for which a Youku client is installed, and can access media resources in a media resource library of a third-party video website in addition to the present video website by a video website. As a result, user experience may also be enhanced.

As shown in FIG. 3, embodiments of the disclosure further provide a system for pushing video to a third party, including:

a request instruction receiving unit configured to receive a video request instruction from a third party, the video request instruction including third-party identification authentication information and third-party video stream identification information;

a video stream list extracting unit configured to retrieve a prestored list of local video streams corresponding to a third party ID according to the third-party ID authentication information contained in the video request instruction from the third party;

a to-be-pushed video stream determining unit configured to determine a video stream to be pushed by comparing the identification information on the third-party video stream in the video request instruction from the third party received by the request instruction receiving unit with local video stream configuration information in the list of video streams acquired by the video stream list extracting unit; and

a video stream pushing unit configured to push the video stream to be pushed, as determined by the to-be-pushed video stream determining unit to the third party.

In some embodiments (taking LETV and Mango TV as examples), the media resource library employed by LETV is composed by itself, while Mango TV employs a media resource library of SOBEY. Therefore, the architectures of two media resource libraries are completely different, and thus the video stream identification information with which the two media resource libraries manage the respective video stream is also different. As a result, direct access to each other's media resource library between the two video platforms becomes impossible. However, the above embodiment realizes access between LETV and Mango TV by presetting a video stream matching list in a local server, i.e., the server of the LETV, and performing the method as shown in FIG. 1 for the received third party's video request instruction.

In this embodiment, the system for pushing video to a third party can be a separate server or a server cluster, and each unit described above can be a separate server or a server cluster. In this event, an interaction between the units is embodied as an interaction between the servers or server clusters corresponding to the units, and the servers or server clusters corresponding to the units together form the system for pushing video to a third party of the disclosure.

In particular, the system for pushing video to a third party formed by the servers or server clusters corresponding to the units includes:

a request instruction receiving server or server cluster configured to receive a video request instruction from a third party, the video request instruction including third-party identification authentication information and third-party video stream identification information;

a video stream list extracting server or server cluster configured to retrieve a prestored list of local video streams corresponding to a third party ID according to the third-party ID authentication information in the video request instruction from the third party received by the request instruction receiving server or server cluster;

a to-be-pushed video stream determining server or server cluster configured to determine a video stream to be pushed by comparing the identification information on the third-party video stream in the video request instruction from the third party received by the request instruction receiving server or server cluster with local video stream configuration information in the list of video streams acquired by the video stream list extracting server or server cluster; and

a video stream pushing server or server cluster configured to push to the third party the video stream to be pushed which is determined by the to-be-pushed video stream determining server or server cluster.

In an alternative embodiment, it is possible that several of the plural units described above together form a server or server cluster. For example, the request instruction receiving unit forms a first server or a first server cluster, the video stream list extracting unit and the to-be-pushed video stream determining unit together form a second server or a second server cluster, and the video stream pushing unit forms a third server or a third server cluster.

In this event, an interaction between the units is embodied as an interaction among the first server to the third server or the first server cluster to the third server cluster, and the first server to the third server or the first server cluster to the third server cluster together form the CDN scheduling system of the disclosure.

In the embodiment described above, the server configures the video stream matching list to include two columns and at least one row, where a first column stores local video stream configuration information on the video to be pushed in a local media resource library, and a second column stores the third-party video stream identification information on the video to be pushed in a third-party media resource library. The third party video stream identification information and local video stream configuration information correspond to each other in each row.

In the embodiment described above, the local video stream configuration information stored in the video stream matching list in the server at least includes identification information and address information on the video streams to be pushed in the local media resource library.

In the embodiment described above, the identification information on the requested video stream includes code rate information and classification information on the video stream to be pushed.

In the embodiment described above, the local media resource library serves at least one third-party platform.

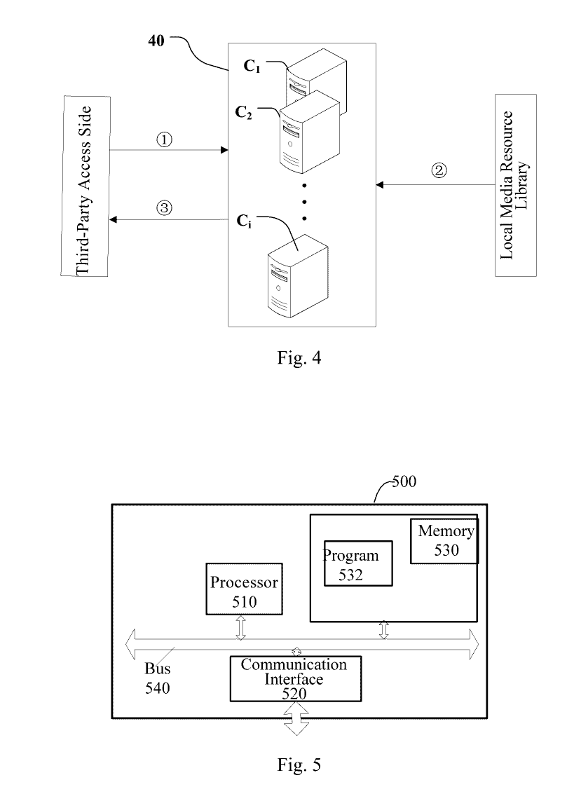

As shown in FIG. 4, it is an architecture diagram in which the method and system for pushing video to a third party of the disclosure are implemented, including a system for pushing video to a third party 40, a third-party access side, a local media resource library, wherein the system for pushing video to a third party 40 includes a plurality of servers C₁ to Cᵢ. In this embodiment, presetting a video stream matching list in servers C₁ to Cᵢ of the system for pushing video to a third party 40 and performing steps (1), (2) and (3), wherein

(1) the system for pushing video to a third party 40 receives the third party's video request instruction transmitted by the user through the third-party access side, to perform part of the steps in the method for pushing video to a third party as shown in FIG. 1:

receiving the video request instruction from the third party, the video request instruction including third-party identification authentication information and third-party video stream identification information;

retrieving a prestored list of local video streams corresponding to the third party ID according to the third-party ID authentication information; and

determining a video stream to be pushed by comparing the third-party video stream identification information with local video stream configuration information in the list of local video streams.

(2) The system for pushing video to a third party 40 acquires video streams to be pushed from the local media resource library according to the determined video stream to be pushed.

(3) The system for pushing video to a third party 40 pushes the acquired video streams to be pushed to the third-party access side.

The third-party access side in this embodiment is an intelligent terminal or a homepage of a website, wherein the intelligent terminal may be a cell phone, e.g., LETV Phone, may also be a portable, pocket-sized, hand-held, computer's built-in or in-vehicle mobile device, may also be a PC (personal computer), a tablet computer and the like, and may further be a smart television, e.g., LETV, capable of being connected to Internet, a set-top box and the like. Therefore the intelligent terminal can implement acquisition of natural information on targets to be recognized.

An embodiment of an electronic device or a server included in the above-mentioned system for pushing video to a third party including:

a memory for storing a computer operation instruction;

a processor for performing the computer operation instruction stored in the memory to implement the steps of:

receiving a video request instruction from a third party, the video request instruction including third-party identification authentication information and third-party video stream identification information;

retrieving a prestored list of local video streams corresponding to a third party ID according to the third-party ID authentication information;

determining a video stream to be pushed by comparing the third-party video stream identification information with local video stream configuration information in the list of local video streams; and

pushing the video stream to be pushed to the third party.

An embodiment of the present application provides a non-transitory computer-readable storage medium storing executable instructions that, when executed by an electronic device, cause the electronic device to execute the method for pushing video to a third party mentioned above.

FIG. 5 is a structural schematic view of an embodiment of an electronic device or the servers C₁ to Cᵢ included in the system for pushing video to a third party 40 in the above-mentioned embodiments of the disclosure. Hereinafter, 500 is used as a reference numeral of the electronic device or the servers included in the system for pushing video to a third party 40. The particular embodiments of the present application do not define the particular implementation manners of the server 500. The electronic device or the server includes:

a processor 510, a communications interface 520, a memory 530 and a communications bus 540, wherein

the processor 510, the communications interface 520 and the memory 530 complete communications between each other via the communications bus 540.

The communications interface 520 is used for communicating with a network element, e.g., the third-party access side and the like.

The processor 510 is used for execution of programs 532. In particular, the relevant steps in the embodiments of the above-mentioned method can be implemented.

In particular, the programs 532 may include program codes including a computer operation instruction.

The processor 510 may be a central processing unit (CPU), or an application specific integrated circuit (ASIC), or configured to implement one or more integrated circuits of the embodiments of the present application.

The method and system for pushing video to third-party provided in embodiments of the present invention implement sharing of different video streams between different video platforms by presetting a video stream matching list in a server, and implement a response to a video request between different websites. That is, some video website, e.g., LETV, can respond to a video request instruction of a third-party video website or terminal, e.g., Youku or an electronic terminal in which a Youku client is installed, and can access media resources in a media resource library of a third-party video website in addition to the present video website by a video website. On the other hand, user experience can also be enhanced.

The above described embodiments of the devices are merely illustrative, wherein the all units described as separate components may be or may not be physically separated, and components named as units may be or may not be physical units; that is, the components can be located at a place, or distributed to multiple network elements. According to actual needs, part of or all of the modules can be selected to realize purposes of the embodiments of the disclosure. Those of ordinary skill in the art can understand and implement it without carrying out any creative work.

Through the above described embodiments, those skilled in the art can clearly understand that various embodiments may be implemented by software plus a necessary universal hardware platform, and of course by hardware. Based on this understanding, the nature of the technical solutions or those parts contributing over the prior art may be embodied in the form of a software product. The computer software product may be stored in a computer readable storage medium, such as ROM/RAM, magnetic discs, CD-ROM, etc., and includes several instructions to instruct a computer device (may be a personal computer, server, or network equipment) to perform the method of various embodiments or some parts of the embodiment.

It would be appreciated by the skilled in the art that, the embodiments of the disclosure can be provided as method, system, or computer program product. Therefore, the disclosure can be implemented in various ways, such as purely by hardware, or purely by software, or a combination of software and hardware. Moreover, the disclosure can be implemented as a computer program product including one or more computer executable program codes which are stored on a computer readable memory medium (including but not limited to a disk storage or optic memory, etc.).

The disclosure is described in reference to method, device (or system), and flow chart and/or block diagram of computer program product of embodiment of the invention. It should be understood that each flow and/or block and a combination thereof in a flow chart and/or block diagram can be implemented by computer program instruction. These computer program instruction can be provided to a universal computer, a dedicated computer, an embedded processor or a processor of other programmable data processing device to generate a machine, so that a device capable of realizing functions designated by one or more flows of a flow chart and/or one or more blocks of a block diagram can be generated through execution of instructions by a computer or processor of other programmable data processing device.

These computer program instructions may be stored in a computer readable memory which can guide the computer or other programmable data processing device to operate in a special way, so that the instruction stored in the computer readable memory generates a product including an instruction device which carries out functions designated by one or more flows of a flow chart and/or one or more blocks of a block diagram. These computer program instructions can also be loaded on a computer or other programmable data processing device so as to enable a series of operations to be carried out on the computer or other programmable device to realize processing of the computer, thus providing operations for achieving functions designated by one or more flows of a flow chart and/or one or more blocks of a block diagram by the instructions executed by the computer or other programmable device.

Finally, it should be noted that, the above embodiments are merely provided for describing the technical solutions of the disclosure, but not intended as a limitation. Although the disclosure has been described in detail with reference to the embodiments, those skilled in the art will appreciate that the technical solutions described in the foregoing various embodiments can still be modified, or some technical features therein can be equivalently replaced. Such modifications or replacements do not make the essence of corresponding technical solutions depart from the spirit and scope of technical solutions embodiments of the disclosure.

None of the elements recited in the claims are intended to be a means-plus-function element within the meaning of 35 U.S.C. §112(f) unless an element is expressly recited using the phrase “means for,” or in the case of a method claim using the phrases “operation for” or “step for.”

What is claimed is:

1. A method for pushing video to a third party, applied to an electronic device, comprising:
receiving a video request instruction from a third party, the video request instruction comprising third-party identification authentication information and third-party video stream identification information;
retrieving a prestored list of local video streams corresponding to a third party ID according to the third-party ID authentication information;
determining a video stream to be pushed by comparing the third-party video stream identification information with local video stream configuration information in the prestored list of local video streams; and
pushing the video stream to be pushed to the third party.

2. The method for pushing video to a third party of claim 1, wherein the prestored list of local video streams at least comprises the third-party video stream identification information and the local video stream configuration information corresponding to the third-party video stream identification information.

3. The method for pushing video to a third party of claim 1, wherein the local video stream configuration information at least comprises identification information and address information on the video streams to be pushed in a local media resource library.

4. The method for pushing video to a third party of claim 3, wherein the local media resource library serves at least one third-party platform.

5. An electronic device, comprising:
at least one processor; and
a memory communicably connected with the at least one processor for storing instructions executable by the at least one processor, wherein execution of the instructions by the at least one processor causes the at least one processor to:
receive a video request instruction from a third party, the video request instruction comprising third-party identification authentication information and third-party video stream identification information;
retrieve a prestored list of local video streams corresponding to a third party ID according to the third-party ID authentication information;
determine a video stream to be pushed by comparing the third-party video stream identification information with local video stream configuration information in the prestored list of video streams; and
push the video stream to be pushed to the third party.

6. The electronic device of claim 5, wherein the prestored list of local video streams at least comprises the third-party video stream identification information and the local video stream configuration information corresponding to the third-party video stream identification information.

7. The electronic device of claim 5, wherein the local video stream configuration information at least comprises identification information and address information on the video streams to be pushed in a local media resource library.

8. The electronic device of claim 7, wherein the local media resource library serves at least one third-party platform.

9. A non-transitory computer-readable storage medium storing executable instructions that, when executed by an electronic device, cause the electronic device to:
receive a video request instruction from a third party, the video request instruction comprising third-party identification authentication information and third-party video stream identification information;
retrieve a prestored list of local video streams corresponding to a third party ID according to the third-party ID authentication information;
determine a video stream to be pushed by comparing the third-party video stream identification information with local video stream configuration information in the prestored list of video streams; and
push the video stream to be pushed to the third party.

10. The non-transitory computer-readable storage medium of claim 9, wherein the list of local video streams at least comprises the third-party video stream identification information and the local video stream configuration information corresponding to the third-party video stream identification information.

11. The non-transitory computer-readable storage medium of claim 9, wherein the local video stream configuration information at least comprises identification information and address information on the video streams to be pushed in a local media resource library.

12. The non-transitory computer-readable storage medium of claim 11, wherein the local media resource library serves at least one third-party platform.
